(19) United States
(12) Patent Application Publication
(10) Pub. No.: US 2025/0047190 A1
(43) Pub. Date: Feb. 6, 2025

(54) MODE TRANSITIONS FOR BUCK CONVERTERS

(71) Applicant: Texas Instruments Incorporated, Dallas, TX (US)

(72) Inventors: Janne Pahkala, Oulu (FI); Juha Hauru, Oulu (FI); Ari Vaananen, Oulu (FI)

(21) Appl. No.: 18/544,366

(22) Filed: Dec. 18, 2023

Related U.S. Application Data
(60) Provisional application No. 63/530,715, filed on Aug. 4, 2023.

(51) Int. Cl. H02M 1/088; H02M 3/158

(52) U.S. Cl. CPC H02M 1/088; H02M 3/158

(57) ABSTRACT

An example apparatus includes: switch control circuitry; and mode control circuitry configured to: in response to a determination that the switch control circuitry is to be operated in a fixed frequency mode, signal a switch control circuitry transition to the switch control circuitry configured to transition the switch control circuitry to an on-time control mode to transmit an on-time control pulse signal to a switch; and in response to the switch control circuitry transition to the on-time control mode, signal the switch control circuitry configured to transmit a fixed frequency mode clock signal to the switch.

### CROSS-REFERENCE TO RELATED APPLICATION

This patent application claims the benefit of and priority to U.S. Provisional Patent Application Ser. No. 63/530,715 filed Aug. 4, 2023, which Application is hereby incorporated herein by reference in its entirety.

### TECHNICAL FIELD

This description relates generally to voltage converters and, more particularly, to mode transitions for buck converters.

### BACKGROUND

A voltage converter changes the voltage of an electrical power source. A buck converter, also known as a step down converter, decreases an input voltage from an input while increasing a current to the output. A buck converter is a switched-mode power controller that utilizes at least one transistor that is switched on and off to control transmission of the input signal to an energy storage element such as one or more inductors and/or capacitors.

### BRIEF DESCRIPTION OF THE DRAWINGS

FIG. 1 is a block diagram of an example buck converter.

FIG. 2 is a block diagram of an example implementation of the mode control circuitry of FIG. 1.

FIG. 3 is a circuit diagram of an example implementation for the buck converter of FIG. 1.

FIG. 4 is a flowchart representative of example machine readable instructions and/or example operations that may be executed, instantiated, and/or performed using an example programmable circuitry implementation of the mode control circuitry of FIG. 2.

FIG. 5 is a diagram illustrating example operating parameters of the buck converter.

FIG. 6 is a block diagram of an example processing platform including programmable circuitry structured to execute, instantiate, and/or perform the example machine readable instructions and/or perform the example operations of FIG. 4 to implement the mode control circuitry of FIG. 2.

The same reference numbers or other reference designators are used in the drawings to designate the same or similar (functionally and/or structurally) features.

### DETAILED DESCRIPTION

Buck converters may utilize different types of control schemes such as, for example, hysteretic mode, fixed frequency mode, on-time control mode, etc. Such different control schemes provide different signal stabilities and efficiencies in different environmental conditions (e.g., load conditions).

In hysteretic mode, a buck converter cycles its switch(es) to keep current in an energy storage element (e.g., an inductor will be used in examples herein but any other type or combination of energy storage elements can be utilized in a buck converter) between preset upper and lower boundaries (e.g., by alternatively coupling the inductor to an input voltage (Vin) and ground) to provide an output voltage (Vout). For example, current in an inductor having inductance L ramps up at a rate of Vinductor/L (e.g., (VIN-VOUT)/L for an inductor of a Buck converter during a charging period when a high-side switch is enabled) when the switch couples Vin to the inductor and ramps down at a rate of −Vout/L when the switch decouples the input voltage from the inductor and couples the input to the conductor to ground. Thus, the hysteretic control scheme decouples Vin from the inductor and couples the input to the inductor to ground when the inductor current reaches the upper limit and couples Vin with the inductor when inductor current reaches the lower limit.

In on-time control mode, a buck converter alternately couples Vin to an inductor when inductor current reaches a lower threshold and couples the inductor to ground triggered by a timed pulse signal from an on-time controller driven by a timer. The timing of the timed pulse can be adapted (e.g., can be adapted to generate a switching frequency to generate a set Vout).

In fixed frequency mode, a buck converter alternately couples Vin to an inductor when inductor current reaches a lower threshold and couples the inductor to ground triggered by a fixed time pulse from a timer (e.g., a buck timer). For a fixed frequency mode the switching frequency is fixed but the amount of time that Vin is supplied to the inductor is variable to provide a set Vout (e.g., using pulse width modulation).

A buck converter may include a controller to allow it to operate according to different control schemes. Such a buck controller may transition between such control schemes. For example, the controller may determine to transition based on information about an environment in which the buck converter is operating (e.g., a load), characteristics of the buck controller (e.g., a current at the inductor), an instruction from an outside entity (e.g., from a system controller), etc.

When transitioning between control schemes, it is desirable to avoid disturbances in the output voltage. For example, if a buck converter is switched directly from hysteretic control mode to fixed frequency mode, errors in feedback loop components that control operation in fixed frequency mode can cause disturbances in the output voltage at the transition time and until the values are adapted to the proper operational values for the fixed frequency mode. For example, some buck converters utilize a slope compensation ramp needed in fixed frequency mode to stabilize regulator operation and include a ramp peak value that is fed to a control loop to compensate ramp effect in control loop voltage. These parameters are not utilized in hysteretic mode but will be activated when transitioning to fixed frequency mode. Because the parameters are not properly adapted for the fixed frequency mode upon transition, errors in these parameters may cause errors to inductor current and current sensing circuitry.

To provide for a smooth transition between hysteretic and fixed frequency mode, example buck converters described herein are transitioned between hysteretic mode and fixed frequency mode via temporary operation in on-time control mode. In other words, when it is determined to switch from hysteretic mode to fixed frequency mode, the buck converter is first transitioned from hysteretic mode to on-time control mode and then transitioned from on-time control mode to fixed frequency mode. In some such buck converters, prior to transitioning from one mode to another, one or more control parameters (e.g., clocks, timers, time signals, ramp signals, etc.) are adapted to a set value for the upcoming state prior to the transition. For example, prior to transitioning from hysteretic mode to on-time control mode an on-time generator may be adapted to the length of the period for switching Vin to be supplied to the inductor. Prior to transitioning from on-time control mode to fixed frequency mode, the switching frequency is adapted by comparing the switching period to the length of the buck timer and adjusting the on-time (e.g., pulse width duration). Thus, by switching from hysteretic mode to fixed frequency mode via on-time control mode, the operational parameters of the buck converter can be adapted to the upcoming mode so that a smooth transition can occur without disturbance and error.

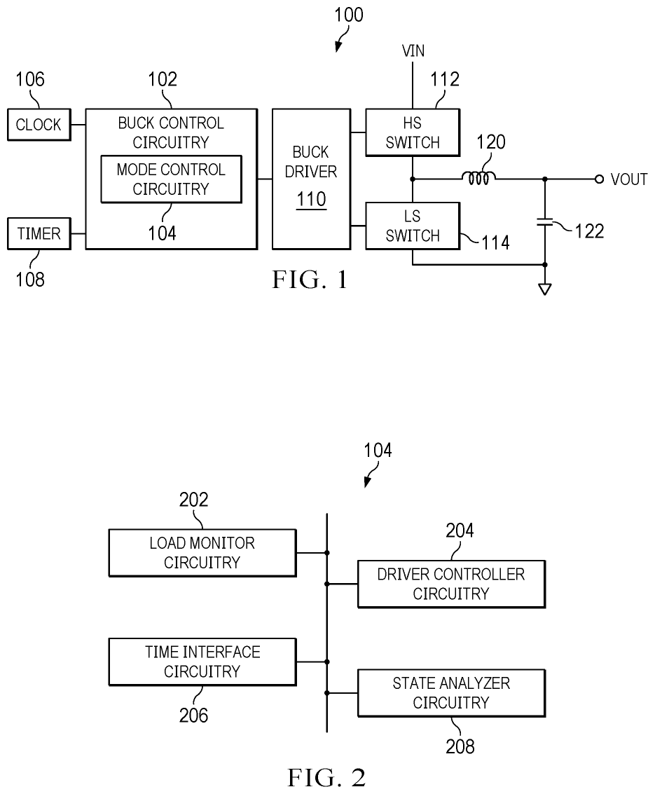

FIG. 1 block diagram of a buck converter circuitry 100 (also referred to as buck converter 100) that includes a buck control circuitry 102 that includes a mode control circuitry 104 to control the operating mode of the buck converter 100. The buck converter 100 includes the buck control circuitry 102, a clock 106, a timer 108, a buck driver 110, a high-side switch 112, a low-side switch 114, an inductor 120, and a capacitor 122.

The buck control circuitry 102 is connected to an output of the clock 106 and an output of the timer 108. The buck control circuitry 102 sends switch control data to the buck driver 110. A first output of the buck driver 110 is connected to the high-side switch 112 and a second output of the buck driver 110 is connected to the low-side switch 114. The high-side switch selectively couples an input signal (Vin) to a first terminal the inductor 120. The low-side switch selectively couples the first terminal of the inductor 120 to ground. A second terminal of the inductor 120 is coupled to ground via the capacitor 122. The second terminal of the inductor 120 is the output (Vout) of the circuit.

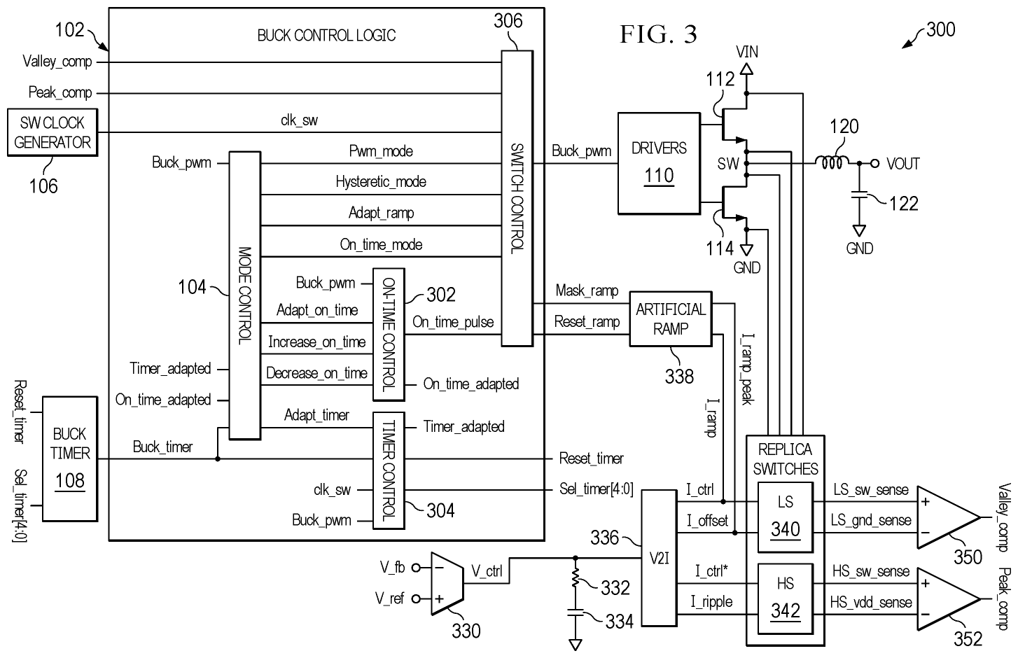

The buck control circuitry 102 controls the operation of the buck converter 100 to convert the input signal Vin to a set output signal Vout. For example, the buck control circuitry controls operation of the buck driver 110 to drive the operation of the high-side switch 112 and the low-side switch 114 to provide a set Vout (e.g., to step down the voltage of Vin to a target Vout). The buck control circuitry 102 obtains the voltage and/or current of Vout as a feedback loop to control the operation (e.g., based on a comparison of an output voltage to a reference voltage level). The buck control circuitry 102 may include any number of sub-components to implement the buck converter 100. For example, the buck control circuitry 102 may include controllers for different operational modes (e.g., an on-time mode controller, a timer controller, a switch controller, etc.). An example implementation of the buck control circuit 102 is described in conjunction with FIG. 3.

The mode control circuitry 104 controls the operational mode of the buck control circuitry 102. The mode control circuitry 104 includes logic to select a mode (e.g., hysteretic mode, on-time mode, fix frequency mode, etc.) and to control the buck control circuitry 102 to operate in the selected mode. For example, the mode control circuitry 104 may monitor a load on the buck converter 100 (e.g., monitor a current through inductor 120) and select an operational mode based on the load.

The mode control circuitry 104 may operate the buck control circuitry 102 in hysteretic mode during power up/startup of the buck control circuitry 102, during forward and reverse current limit operation, based on a load on the buck circuitry (e.g., when a load is low), during entry or exit of a pulsed frequency modulation (PFM) operation, etc. When the conditions for hysteretic mode operation are no longer present, the mode control circuitry 104 adapts the buck control circuitry and the clock 106 for on-time control mode, transitions the buck control circuitry 102 to on-time control mode, adapts the timer 108 to fixed frequency mode, and transitions the buck control circuitry 102 to fixed frequency mode. Alternatively, any other type of mode transition stimulus may be utilized (e.g., the mode control circuitry 104 may analyze any other circuit parameter to indicate a need for transition, may transition based on a timer from a startup time, may transition based on an external stimulus or control signal, etc.).

Adapting the buck control circuitry 102 to prepare for transition to a mode may include adapting clocks, timers, enabling circuitry (e.g., circuitry to generate a ramp signal), waiting a set amount of time (e.g., a number of steps and/or cycles of a component), etc. As used herein, adapting means adjusting a component to an operational state to be utilized in the future operational mode. For example, adapting a clock or timer means adjusting the clock or timer to have a frequency that matches a frequency to be used by the future operational state. By adapting a component prior to transition to the operational stage, a smooth transition between operational modes can occur rather than disturbances that are exhibited when components are adjusted during or after a transition occurs.

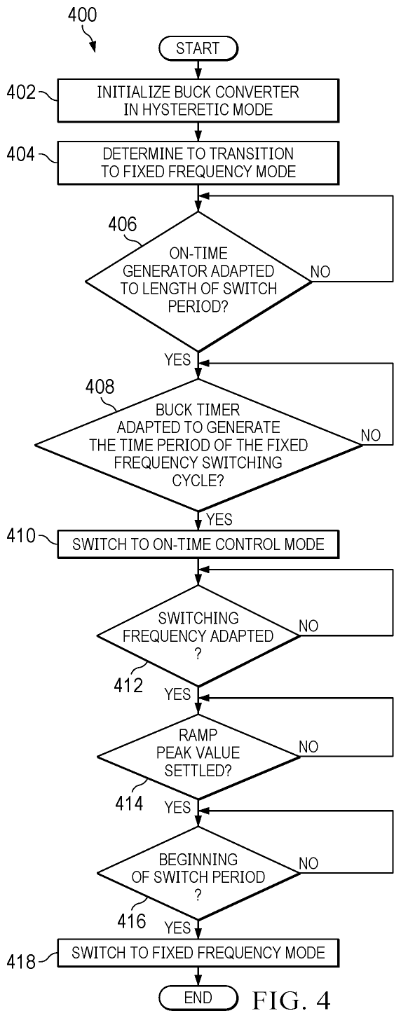

The mode control circuitry 104 is a logic circuit implementing instructions for controlling the buck control circuitry 102 and controlling mode transitions. An example implementation of the mode control circuitry 104 is described in conjunction with FIG. 2 and the flowchart of FIG. 4. Alternatively, mode control circuitry 104 may be implemented by processor circuitry executing instructions, Application Specific Integrated Circuit (ASIC), a Field Programmable Gate Array (FPGA), etc. or any combination of such logic circuitry.

The clock 106 generates a clock signal for timing the operation of the high-side switch 112 and the low-side switch 114. The clock 106 is an integrated circuit that outputs a signal (e.g., a pulse) at a set frequency.

The timer 108 generates a timer signal that is utilized by the buck control circuitry 102 to control the operation of the switches 112, 114 for pulse width modulation during on-time control mode. The timer 108 is an integrated circuit that outputs a signal (e.g., a pulse) at a set frequency. The frequency is controlled by the mode control circuitry 104.

The buck driver 110 receives a signal from the buck controller circuitry 102 indicating the control of the switches 112, 114 and converts the signal into a first control signal for the high-side switch 112 and a second control signal for the low-side switch 114. The buck driver 110 is an integrated circuit includes circuitry to selectively 1) drive the high-side switch 112 on and the low-side switch 114 off and 2) drive the high-side switch 112 off and the low-side switch 114 off.

The high-side switch 112 is a gate-controlled N-channel metal-oxide semiconductors (NMOS) to selectively couple the inductor 120 to Vin. The low-side switch 114 is a gate-controlled NMOS to selectively couple the inductor 120 to ground. The switches 112, 114 may alternatively be implemented by another type of transistor or another type of switch device.

The inductor 120 and capacitor 122 implement the LC output circuitry of the buck converter 100. Alternatively, any other type of output circuit (e.g., another energy storage arrangement) may be utilized.

FIG. 2 is a block diagram of an example implementation of the mode control circuitry 104 of FIG. 1 to do control an operational mode of the buck control circuitry 102. The mode control circuitry 104 of FIG. 2 may be instantiated (e.g., creating an instance of, bring into being for any length of time, materialize, implement, etc.) by programmable circuitry such as a Central Processor Unit (CPU) executing first instructions. Also, the mode control circuitry 104 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. Some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The mode control circuitry 104 of FIG. 2 includes load monitor circuitry 202, driver controller circuitry 204, time interface circuitry 206, and state analyzer circuitry 208.

The load monitor circuitry 202 monitors a load on the buck converter 100 to determine when a mode transition is to be controlled. The load monitor circuitry 202 monitors the current in the inductor 120 to determine the load level. Alternatively, the load monitor circuitry 202 may monitor a voltage drop across the capacitor 122, a current flow at another point in the buck converter 100, a signal indicating a load, etc. Alternatively, rather than monitoring load, the load monitor circuitry 202 may determine other information indicative of when a mode transition is to occur. For example, the load monitor circuitry 202 may monitor a timer that tracks a time from the startup of the buck converter 100, a timer that tracks a time since a reset of the buck converter 100, a communication signal indicating an external trigger to perform a mode transition, etc.

The driver controller circuitry 204 provides a signal to buck control circuitry to control the buck driver 110 according to a selected operational mode of the buck converter 100. The driver controller circuitry 204 signals the buck control circuitry 102 to indicate which system signals/parameters are to be utilized in driving the buck driver 110 to operate the high-side switch 112 and the low-side switch 114.

The time interface circuitry 206 interfaces the mode control circuitry 104 with the timer clock 106 and the timer 108. The time interface circuitry 206 analyzes a current timing of the clock 106 and the timer 108, determines if the timing of the clock 106 and/or the timer 108 is to be adapted, and, if so, signals the clock 106 and/or the timer 108 to adjust the timing.

The state analyzer circuitry 208 collects information from the load monitor circuitry and the time interface circuitry 206 and directs the driver controller circuitry 204 to control transition among states. The state analyzer circuitry 208 determines a condition for hysteretic mode is present (e.g., that a load on the circuitry is low, at a transition to current limit operation, during power up/startup of the buck converter 100, during an exist from a pulse frequency modulation operation, etc.) and initiates the driver controller circuitry 204 to operate in the hysteretic mode. The state analyzer circuitry 208 further determines that a condition for hysteretic mode is no longer active and, therefore, determines that the buck converter 100 is to transition to the fixed frequency mode. In response to that determination, the state analyzer circuitry 208 adapts the buck converter 100 to transition to on-time control mode and transitions the buck control circuitry 102 to on-time control mode. Next, the state analyzer circuitry 208 adapts the buck converter 100 to fixed frequency mode and transitions the buck control circuitry 102 to fixed frequency mode.

In some examples, the circuitry 202, 204, 206, and/or 208 are instantiated by programmable circuitry executing instructions and/or configured to perform operations such as those represented by the flowchart of FIG. 4.

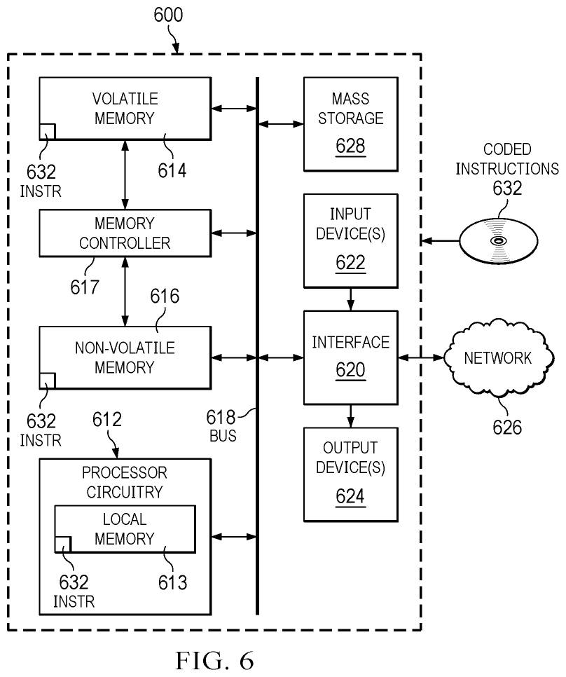

In some examples, the mode control circuitry 104 includes means load monitor, means for driver control, means for time interface, and/or means for state analysis. In some examples, one or more of the means may be instantiated by programmable circuitry such as the example programmable circuitry 612 of FIG. 6. For instance, the means may be instantiated by a microprocessor executing machine executable instructions such as those implemented by the flowchart of FIG. 4. In some examples, means may be instantiated by hardware logic circuitry, which may be implemented by an ASIC, XPU, FPGA circuitry, etc. configured and/or structured to perform operations corresponding to the machine readable instructions. Also, the means may be instantiated by any other combination of hardware, software, and/or firmware. For example, the means may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the mode control circuitry 104 of FIG. 1 is illustrated in FIG. 2, one or more of the elements, processes, and/or devices illustrated in FIG. 2 may be combined, divided, re-arranged, omitted, eliminated, and/or implemented in any other way. Further, the load monitor circuitry 202, the driver controller circuitry 204, the time interface circuitry 206, the state analyzer circuitry 208, and/or, more generally, the example mode control circuitry 104 of FIG. 2, may be implemented by hardware alone or by hardware in combination with software and/or firmware. Thus, for example, any of, the load monitor circuitry 202, the driver controller circuitry 204, the time interface circuitry 206, the state analyzer circuitry 208, and/or, more generally, the example mode control circuitry 104, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example mode control circuitry 104 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the mode control circuitry 104 of FIG. 2 and/or representative of example operations which may be performed by programmable circuitry to implement and/or instantiate the mode control circuitry 104 of FIG. 2, are shown in FIG. 4. The machine readable instructions may be one or more executable programs or portion(s) of one or more executable programs for execution by programmable circuitry such as the programmable circuitry 612 shown in the example processor platform 600 described below in connection with FIG. 6. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 4, many other methods of implementing the example mode control circuitry 104 may alternatively be used. For example, the order of execution of the blocks of the flowchart(s) may be changed, and/or some of the blocks described may be changed, eliminated, or combined. Also, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a circuit diagram of an example implementation of the buck converter 100 of FIG. 1. The buck converter 100 of FIG. 3 includes the buck control circuitry 102, which includes the mode control circuitry 104, an on-time controller 302, a timer controller 304, and a switch controller 306. The buck converter 100 further includes the clock 106, the timer 108, the buck driver 110, the high-side switch 112, the low-side switch 114, the inductor 120, the capacitor 122, a differential amplifier 330, a resistor 332, a capacitor 334, a voltage to current converter 336, an artificial ramp generator 338, a low-side replica switch 340, a high-side replica switch 342, a low-side comparator 350, and a high-side comparator 352.

The timer 108 includes a first input coupled to the reset_timer output of the timer controller 304 and a second input coupled to the sel_timer[4:0] output of the timer controller 304.

The mode control circuitry 104 includes a first input coupled to a buck_pwm output of the switch controller 306, a second input coupled to the timer_adapted output of the timer controller 304, a third input coupled to an on_time_adapted output of the on-time controller 302, and a fourth input coupled to the buck_timer output of the timer 108.

The on-time controller 302 includes a first input coupled to a buck_pwm output of the switch controller 306, a second input coupled to an adapt_on_time output of the mode control circuitry 104, a third input coupled to an increase_on_time output of the mode control circuitry 104, and a fourth input coupled to a decrease_on_time output of the mode control circuitry 104.

The timer controller 304 includes a first input coupled to the adapt_timer output of the mode control circuitry 104, a second input coupled to a clk_sw output of the clock 106, and a third input coupled to the buck_pwm output of the switch controller 306.

The switch controller 306 includes a first input coupled to a valley_comp output of the low-side comparator 350, a second input coupled to the peak_comp output of the high-side comparator 352, a third input coupled the clk_sw output of the clock 106, a fourth input coupled a pwm_mode (e.g., fixed frequency mode) output of the mode control circuitry 104, a fifth input coupled the hysteretic_mode output of the mode control circuitry 104, a sixth input coupled the coupled to the adapt_ramp output of the mode control circuitry 104, a seventh input coupled to an on_time_mode output of the mode control circuitry 104, and an eight input coupled to an on_time_pulse output of the on-time controller 302.

The buck driver 110 includes a first input coupled to the buck_pwm output of the switch controller 306. A gate of the high-side switch 112 is coupled to a first output of the buck driver 110, a drain of the high-side switch 112 is coupled to an input signal VIN, and a source of the high-side switch 112 is coupled to a first terminal of the inductor 120. A gate of the low-side switch 112 is coupled to a second output of the buck driver 110, a drain of the low-side switch is coupled to the inductor 120, and a source of the low-side switch 114 is coupled to a ground connection.

A second terminal of the inductor 120 is coupled to a first terminal of the capacitor 122 and is also the output (VOUT) of the buck converter 100. A second terminal of the capacitor 122 is coupled to a ground connection.

A negative terminal of the differential amplifier 330 is coupled to a voltage feedback v_fb (e.g., coupled to VOUT) and a positive terminal of the differential amplifier 330 is coupled to a target reference voltage value v_ref input to the buck converter 100. A first terminal of the resistor 332 is coupled to an output v_ctrl (e.g., a value indicative of the error between the target reference voltage value and the voltage feedback value) of the differential amplifier 330. A first terminal of the capacitor 334 is coupled to a second terminal of the resistor 332 and a second terminal of the capacitor 334 is coupled to a ground connection.

A first input of the voltage to current converter 336 is coupled to the output v_ctrl of the differential amplifier 330.

The artificial ramp generator 338 includes a first input coupled to a mask_ramp output of the switch controller 306 and a second input coupled to a reset_ramp output of the switch controller 306. The low-side replica switch 340 includes a first input coupled to an I_ramp output of the artificial ramp generator 338 and an I_ctrl output of the voltage to current converter 336. The low-side replica switch 340 includes a second input coupled to an I_ramp_peak output of the artificial ramp generator 338 and an I_offset output of the voltage to current converter 336. For example, the low-side replica switch 340 may include two switches (e.g., transistors) where a first low-side replica switch is connected to the first terminal of the inductor 120 (SW node) and a second low-side replica switch is connected to connected the source of the low-side switch (GND node).

The high-side replica switch 342 includes a first input coupled to an I_ctrl* output of the voltage to current converter 336. The high-side replica switch 342 includes a second input coupled to an I_ripple output of the voltage to current converter 336. For example, the high-side replica switch 342 may include two switches (e.g., transistors) where a first high-side replica switch is connected to the first terminal of the inductor 120 (SW node) and a second high-side replica switch is connected to connected the coupled to the input signal (VIN node).

The low-side comparator 350 includes a positive terminal coupled to a ls_sw_sense output of the low-side replica switch 340 and a negative terminal coupled to a ls_gnd_sense output of the low-side replica switch 340. The high-side comparator 350 includes a positive terminal coupled to a hs_sw_sense output of the high-side replica switch 342 and a negative terminal coupled to a hs_vdd_sense output of the high-side replica switch 342.

When the mode control circuitry 104 operates the buck control circuitry 102 in hysteretic mode, the buck control circuitry 102 controls the buck driver 110 to enable the high-side switch 112 and disable the low-side switch 114 based on valley_comp, which indicates that the current in the inductor 120 is at a controlled level (e.g., a ground level, a low level, etc.) defined by the I_ctrl and I_offset currents while the low-side switch 114 is enabled. Also when the mode control circuitry 104 operates the buck control circuitry 102 in hysteretic mode, the buck control circuitry 102 controls the buck driver 110 to disable the high-side switch 112 and enable the low-side switch 114 based on peak_comp, which indicates that the current in the inductor 120 is at a peak level while the high-side switch 112 is enabled. When the mode control circuitry 104 triggers the hysteretic_mode output, the switch controller 306 sets mask_ramp to high and reset_ramp to high. The I_ripple and I_ctrl* signals define the peak comparator trigger level. I_ctrl* current amplitude is equal to I_ctrl amplitude but at opposite polarity. Thus, the high-side comparator 352 level is higher than the low-side comparator 350 level and the hysteresis between these comparators depends on I_ripple current, which results in 500 mA of inductor current. If valley_comp level is adjusted by the control loop (v_ctrl) to 1A level, peak_comp would trigger at 1.5A.

When the mode control circuitry 104 determines to transition to fixed frequency mode, the mode control circuitry 104 sets adapt_timer to high to signal the timer controller 304 to adapt the timer 108 to match with the period of the clock 106 and to set reset_timer to high at every first rising edge of clk_sw and low at every second rising edge of clk_sw. The timer controller 304, on the second rising edge of clk_sw, determines if the buck_timer has triggered. If the buck_timer has not triggered, the timer controller 304 adjust the timer 108 to operate faster by decreasing the sel_timer control word one step. If the buck_timer has triggered, the timer controller 304 will adjust the timer 108 to slower by increasing sel_timer control word one step. Once the sel_timer has stepped up and down a threshold number of timers (e.g., 7), sel_timer is frozen and timer_adapted signal is set to high. The mode controller 104 sets adapt_on_time to high to adapt the on-time controller 302 to match with the actual period of the high-side switch 112 to prepare for the transition to on-time control mode.

The on-time controller 302 includes a digital timer which will start to generate on_time when buck_pwm signal rises (e.g., at the beginning of a high-side period). If on_time clapses before buck_pwm signal falls (e.g., buck goes to low-side due to peak_comp), the on-time controller 302 generates the on_time_pulse. If the on_time pulse does not occur, the on-time controller 302 adjusts the timer faster, since it is longer than the high-side period. If the on_time_pulse occurs, the on_time_controller adjusts the timer slower, since it is shorter than the actual high-side period. Once the on_timer has stepped up and down a threshold number of times (e.g., 7 times), the on-time controller 302 sets on_time_adapted signal to high to indicate that the signal has been adapted and, in response, the mode controller 104 transitions to the buck control circuitry 102 to on-time control mode.

In on-time control mode, the buck control circuitry 102 controls the buck driver 110 to enable the high-side switch 112 and disable the low-side switch 114 based on valley_comp, which indicates that the current in the inductor 120 is at the controlled level (e.g., a positive controlled level or a negative controlled level) while the low-side switch 114 is enabled. Also, when the mode control circuitry 104 operates the buck control circuitry 102 in on-time control mode, the buck control circuitry 102 controls the buck driver 110 to disable the high-side switch 112 and enable the low-side switch 114 based on on_time_pulse. The switch controller 306 causes the artificial ramp generator 338 to operate even though the I_ramp and I_ramp_peak are not driven to the replica switches 340, 342 since mask_ramp is high. The mode control circuitry 104 outputs high on on_time_mode and the switch controller 306 sets buck_pwm signal to high, mask_ramp high, and reset_ramp follows buck_pwm signal (e.g., low during the low-side period and high during the high-side period).

The mode control circuitry 104 adapts the switching frequency to match with the target switching frequency (clk_sw) by adjusting the on-time controller 302 based on buck_timer. The timer controller 304 adapts buck_timer to the clk_sw period, which is the target for adaption of the switching frequency to prepare for fixed frequency mode. The timer controller 304 sets reset_timer to low in the first rising edge of buck_pwm and high in the second rising edge of buck_pwm. If buck_timer elapses during the switching cycle, the actual switching period is longer than the buck_timer (e.g., period of clk_sw). The mode controller 104 compares if the buck_timer rises before the second rising edge of buck_pwm and, if so, the mode controller decreases the on-time (high-side period length) by setting decrease_on_time signal to high. Alternatively, if the buck_timer does not rise before the second rising edge of buck_pwm signal, the buck switching period is shorter than buck_timer and the mode controller 104 increases the on_time (high-side period length) by setting increase_on_time signal to high. Once the on_timer has stepped up and down a threshold number of times (e.g., 7 times), the switching frequency of the timer 108 is adapted. The mode control circuitry 104 sets adapt_ramp to high for certain time period (e.g., 20 μs) to give settling time for ramp peak value sampling. Once the ramp settling time is elapsed, the mode controller 104 sets pwm_mode signal to high in the falling edge of the pwm_mode to transition to fixed frequency mode.

In fixed frequency mode, the buck control circuitry 102 controls the buck driver 110 to enable the high-side switch 112 and disable the low-side switch 114 based on valley_comp, which indicates that the current in the inductor 120 has reached the controlled level (e.g., ground level) while the low-side switch 114 is enabled. Also, when the mode control circuitry 104 operates the buck control circuitry 102 in fixed frequency mode, the buck control circuitry 102 controls the buck driver 110 to disable the high-side switch 112 and enable the low-side switch 114 based on clk_sw. The I_ramp and I_ramp_peak are generated during the low-side period. The mode control circuitry 104 outputs pwm_mode to high. The switch controller 306 sets buck_pwm signal to high, mask_ramp to low, and reset_ramp to follow buck_pwm signal (e.g., low during low-side period and high during high-side period).

FIG. 4 is a flowchart representative of example machine readable instructions and/or example operations 400 that may be executed, instantiated, and/or performed by programmable circuitry to control the operating mode of the buck converter 100. The example machine-readable instructions and/or the example operations 400 of FIG. 4 begin at block 402, at which the state analyzer circuitry 208 causes the driver controller circuitry 204 to initialize the buck control circuitry 102 in hysteretic mode. The state analyzer circuitry 208 determines to transition the buck control circuitry 102 to fixed frequency operation mode based on load information determined by the load monitor circuitry 202 (block 404). The time interface circuitry 206 determines if the on-time controller 302 is adapted to the length of a switch period (e.g., a high-side switch period) (block 406) and continues to wait until the on-time controller 302 is adapted. The time interface circuitry 206 determines if the timer 108 is adapted to generate the time period of the fixed frequency switching period (block 408) and continues to wait until the timer 108 is adapted.

The driver controller circuitry 204 then switches the buck control circuitry 102 to on-time control mode (block 410). The time interface circuitry 206 then determines if the switching frequency is adapted (block 412) and continues to wait until it is adapted. The state analyzer circuitry 208 determines if the ramp peak value has settled (block 414) and continues to wait until it is settled. The state analyzer circuitry 208 determines if the buck control circuitry 102 is at the start of a low-side switching period (block 416) and continues to wait until the start of the low-side switching period. Then, the driver controller circuitry 204 switches the buck control circuitry 102 to fixed frequency mode.

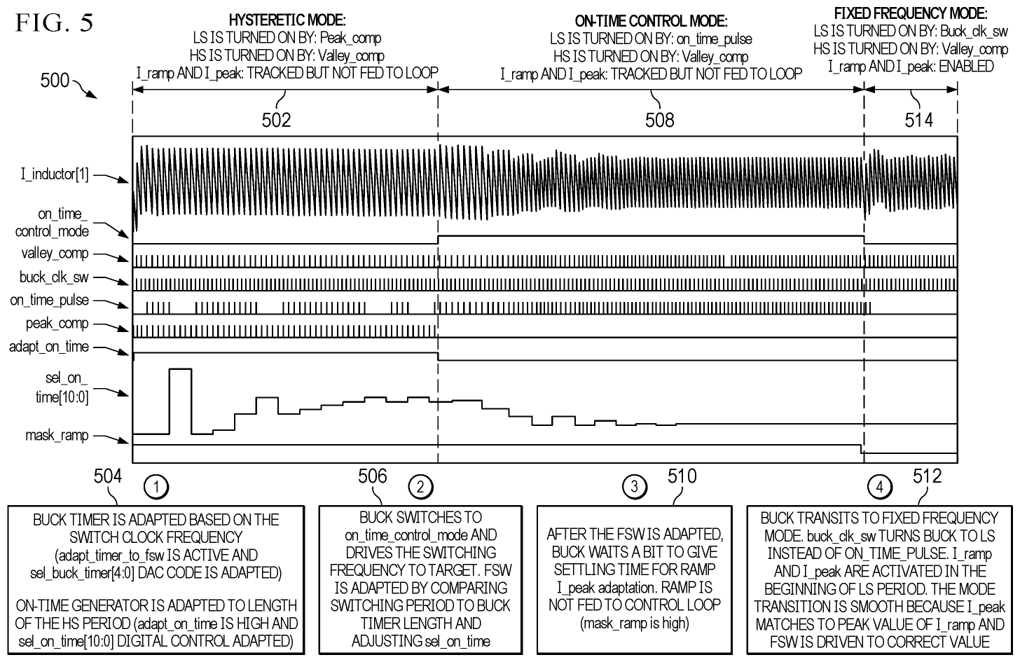

FIG. 5 is a graph 500 illustrating example various control parameters of the buck converter 100 and operating states. As shown in the graph 500, the example circuit begins in the hysteretic mode in region 502. During hysteretic mode, the low side switch 114 is turned on by peak_comp and the high side switch 112 is turned on by valley_comp.

When it is determined to transition to fixed frequency mode, the operations 504 are initiated. Operations 504 include adapting the buck timer 108 based on the clock frequency of the clock 106 (adapt_timer_to_fsw is active and sel_buck_timer[4:0] dac code is adapted) and adapting the On-time generator to a length of the high side period (adapt_on_time is high and sel_on_time[10:0] digital control adapted).

Next, operations 506 are initiated, which includes switching the buck converter 102 to on-time control mode and driving the switching frequency to a target switching frequency. Fsw is adapted by comparing a switching period to a length of the buck timer 108 and adjusting sel_on_time.

During operation in on-time control mode in region 508, the low side switch 114 is turned on by on_time_pulse and the high side switch 112 is turned on by valley_comp.

Next, operations 510 are initiated, which includes, after the fsw is adapted, buck waits a bit to give settling time for ramp I_peak adaptation. During this time, ramp is not fed to control loop (mask_ramp is high).

Once adapted, the buck converter 102 transitions to fixed frequency mode. I_ramp and I_peak are activated in the beginning of a low side period. The mode transition is smooth because I_peak matches to a peak value of I_ramp and fsw is driven to correct value. During fixed frequency mode in region 514, the low side switch 114 is turned on by buck_clk_sw and the high side switch 112 is turned on by valley_comp.

FIG. 6 is a block diagram of an example programmable circuitry platform 600 structured to execute and/or instantiate the example machine-readable instructions and/or the example operations of FIG. 4 to implement the mode control circuitry 104 of FIG. 2. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the load monitor circuitry 202, the driver controller circuitry 204, the time interface circuitry 206, and the state analyzer circuitry 208.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, may include a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIG. 4, may be stored in the mass storage device 628, in the volatile memory 614, in the non-volatile memory 616, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” refers to implementations including any of (1) at least one A, (2) at least one B, or (3) at least one A and at least one B. Similarly, as used herein in the context of describing structures, components, items, objects and/or things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. Semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

In this description, the term “and/or” (when used in a form such as A, B and/or C) refers to any combination or subset of A, B, C, such as: (a) A alone; (b) B alone; (c) C alone; (d) A with B; (c) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Numerical identifiers such as “first,” “second,” “third,” etc. are used merely to distinguish between elements of substantially the same type in terms of structure and/or function. These identifiers as used in the detailed description do not necessarily align with those used in the claims.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

Example methods, apparatus, systems, and articles of manufacture to implement mode transitions for buck converters are disclosed herein. Further examples and combinations thereof include the following:

Example 1 includes an apparatus comprising switch control circuitry, and mode control circuitry configured to in response to a determination that the switch control circuitry is to be operated in a fixed frequency mode, signal a switch control circuitry transition to the switch control circuitry configured to transition the switch control circuitry to an on-time control mode to transmit an on-time control pulse signal to a switch, and in response to the switch control circuitry transition to the on-time control mode, signal the switch control circuitry configured to transmit a fixed frequency mode clock signal to the switch.

Example 2 includes the apparatus of example 1, wherein the switch is a low side switch of buck converter circuitry.

Example 3 includes the apparatus of example 1, wherein the switch control circuitry drives buck converter circuitry.

Example 4 includes the apparatus of example 1, wherein the on-time control pulse is generated based on a comparison of an output voltage of a converter circuitry and a reference voltage.

Example 5 includes the apparatus of example 1, wherein the mode control circuitry is to operate in a hysteretic mode prior to transition to the on-time control mode.

Example 6 includes the apparatus of example 1, wherein the switch is a transistor.

Example 7 includes the apparatus of example 1, wherein the switch is a first switch and the switch control circuitry includes a second switch.

Example 8 includes an apparatus comprising switching circuitry, an inductor coupled to the switching circuitry and an output, a capacitor coupled to the output, buck controller circuitry, and mode control circuitry configured to in response to a determination that the buck controller circuitry is to be operated in a fixed frequency mode, cause the buck controller circuitry to operate in an on-time control mode, and in response to the buck controller circuitry operating in the on-time control mode, cause the buck controller circuitry to operate in the fixed frequency mode.

Example 9 includes an apparatus as defined in example 8, wherein the mode control circuitry is to cause the buck controller circuitry to operate in the fixed frequency mode after a determination that a switching frequency of the buck controller circuitry has been adapted to a target switching frequency.

Example 10 includes an apparatus as defined in example 8, wherein the mode control circuitry is to cause the buck controller circuitry to operate in the fixed frequency mode after a determination that a ramp peak value of the buck controller circuitry has settled.

Example 11 includes an apparatus as defined in example 8, wherein the mode control circuitry is to cause the buck controller circuitry to operate in the fixed frequency mode after a determination the buck controller circuitry is at a start of a switch period.

Example 12 includes an apparatus as defined in example 8, wherein the mode control circuitry is to cause the buck controller circuitry to operate in the fixed frequency mode after a determination that a switching frequency of the buck controller circuitry has been adapted to a target switching frequency, a determination that a ramp peak value of the buck controller circuitry has settled, and a determination the buck controller circuitry is at a start of a switch period.

Example 13 includes an apparatus as defined in example 8, wherein the mode control circuitry is to cause the buck controller circuitry to operate in on-time control mode after a determination that an on-time generator has been adapted to a length of a high-side switch period.

Example 14 includes an apparatus as defined in example 8, further including a buck timer, wherein the mode control circuitry is to cause the buck controller circuitry to operate in on-time control mode after a determination that the buck timer has been adapted to generate a time period of a cycle of the fixed frequency mode.

Example 15 includes a non-transitory computer readable medium comprising instructions that, when executed, cause a machine to at least in response to a determination that a switch control circuitry is to be operated in fixed frequency mode, signal a switch control circuitry transition to the switch control circuitry configured to transition the switch control circuitry to an on-time control mode configured to transmit an on-time control pulse signal to a switch, and in response to the switch control circuitry transition to the on-time control mode, signal the switch control circuitry to transmit a fixed frequency mode clock signal to the switch.

Example 16 includes the non-transitory computer readable medium of example 15, wherein the switch is a low side switch of buck converter circuitry.

Example 17 includes the non-transitory computer readable medium of example 15, wherein the switch control circuitry drives buck converter circuitry.

Example 18 includes the non-transitory computer readable medium of example 15, wherein the on-time control pulse signal is generated based on a comparison of an output voltage of buck controller circuitry and a reference voltage.

Example 19 includes the non-transitory computer readable medium of example 15, wherein the mode control circuitry is to operate in a hysteretic mode prior to transition to the on-time control mode.

Example 20 includes the non-transitory computer readable medium of example 15, wherein the switch is a transistor.

Modifications are possible in the described embodiments, and other embodiments are possible, within the scope of the claims.

What is claimed is:

1. An apparatus comprising:
switch control circuitry; and
mode control circuitry configured to:
in response to a determination that the switch control circuitry is to be operated in a fixed frequency mode, signal a switch control circuitry transition to the switch control circuitry configured to transition the switch control circuitry to an on-time control mode to transmit an on-time control pulse signal to a switch; and
in response to the switch control circuitry transition to the on-time control mode, signal the switch control circuitry configured to transmit a fixed frequency mode clock signal to the switch.

2. The apparatus of claim 1, wherein the switch is a low side switch of buck converter circuitry.

3. The apparatus of claim 1, wherein the switch control circuitry drives buck converter circuitry.

4. The apparatus of claim 1, wherein the on-time control pulse is generated based on a comparison of an output voltage of a converter circuitry and a reference voltage.

5. The apparatus of claim 1, wherein the mode control circuitry is to operate in a hysteretic mode prior to transition to the on-time control mode.

6. The apparatus of claim 1, wherein the switch is a transistor.

7. The apparatus of claim 1, wherein the switch is a first switch and the switch control circuitry includes a second switch.

8. An apparatus comprising:
switching circuitry;
an inductor coupled to the switching circuitry and an output;
a capacitor coupled to the output;
buck controller circuitry; and
mode control circuitry configured to:
in response to a determination that the buck controller circuitry is to be operated in a fixed frequency mode, cause the buck controller circuitry to operate in an on-time control mode; and
in response to the buck controller circuitry operating in the on-time control mode, cause the buck controller circuitry to operate in the fixed frequency mode.

9. An apparatus as defined in claim 8, wherein the mode control circuitry is to cause the buck controller circuitry to operate in the fixed frequency mode after a determination that a switching frequency of the buck controller circuitry has been adapted to a target switching frequency.

10. An apparatus as defined in claim 8, wherein the mode control circuitry is to cause the buck controller circuitry to operate in the fixed frequency mode after a determination that a ramp peak value of the buck controller circuitry has settled.

11. An apparatus as defined in claim 8, wherein the mode control circuitry is to cause the buck controller circuitry to operate in the fixed frequency mode after a determination the buck controller circuitry is at a start of a switch period.

12. An apparatus as defined in claim 8, wherein the mode control circuitry is to cause the buck controller circuitry to operate in the fixed frequency mode after:
a determination that a switching frequency of the buck controller circuitry has been adapted to a target switching frequency;
a determination that a ramp peak value of the buck controller circuitry has settled; and
a determination the buck controller circuitry is at a start of a switch period.

13. An apparatus as defined in claim 8, wherein the mode control circuitry is to cause the buck controller circuitry to operate in on-time control mode after a determination that an on-time generator has been adapted to a length of a high-side switch period.

14. An apparatus as defined in claim 8, further including a buck timer, wherein the mode control circuitry is to cause the buck controller circuitry to operate in on-time control mode after a determination that the buck timer has been adapted to generate a time period of a cycle of the fixed frequency mode.

15. A non-transitory computer readable medium comprising instructions that, when executed, cause a machine to at least:
in response to a determination that a switch control circuitry is to be operated in fixed frequency mode, signal a switch control circuitry transition to the switch control circuitry configured to transition the switch control circuitry to an on-time control mode configured to transmit an on-time control pulse signal to a switch; and
in response to the switch control circuitry transition to the on-time control mode, signal the switch control circuitry to transmit a fixed frequency mode clock signal to the switch.

16. The non-transitory computer readable medium of claim 15, wherein the switch is a low side switch of buck converter circuitry.

17. The non-transitory computer readable medium of claim 15, wherein the switch control circuitry drives buck converter circuitry.

18. The non-transitory computer readable medium of claim 15, wherein the on-time control pulse signal is generated based on a comparison of an output voltage of buck controller circuitry and a reference voltage.

19. The non-transitory computer readable medium of claim 15, wherein the mode control circuitry is to operate in a hysteretic mode prior to transition to the on-time control mode.

20. The non-transitory computer readable medium of claim 15, wherein the switch is a transistor.
